(19) United States
(12) Patent Application Publication
(10) Pub. No.: US 2018/0121218 A1
(43) Pub. Date: May 3, 2018

(54) METHOD FOR OPERATING AN ASSISTANCE SYSTEM AND ASSISTANCE SYSTEM

(71) Applicant: AUDI AG, Ingolstadt (DE)

(72) Inventors: Christian WALL, Hitzhofen (DE); Matthias WUNDERLICH, Ingolstadt (DE)

(73) Assignee: AUDI AG, Ingolstadt (DE)

(21) Appl. No.: 15/543,544

(22) PCT Filed: Jul. 14, 2016
(86) PCT No.: PCT/EP2016/066747

§ 371 Date: Jul. 13, 2017

(30) Foreign Application Priority Data
Jul. 21, 2015 (DE) 10 2015 213 679.5

(51) Int. Cl. G06F 9/44; B60Q 3/20; B60K 35/00; G06Q 30/00

(52) U.S. Cl. CPC G06F 9/4446; B60Q 3/20; B60K 2350/108; G06Q 30/016; B60K 35/00

(57) ABSTRACT

The following assistance functions: (a) an operating instruction for the motor vehicle, stored on a memory device of at least one motor vehicle; (b) an operating instruction for the motor vehicle stored on a vehicle-external server device; and (c) a telephone connection to a customer advisor, are made available by an assistance system of at least one motor vehicle and a vehicle-external server device. The assistance system determines a vehicle function of the motor vehicle required to provide requested assistance for a vehicle occupant and generates an output from at least one assistance function, previously made available, by at least one output device of the motor vehicle in accordance with the vehicle function that was determined and/or a sensed user input by the vehicle occupant.

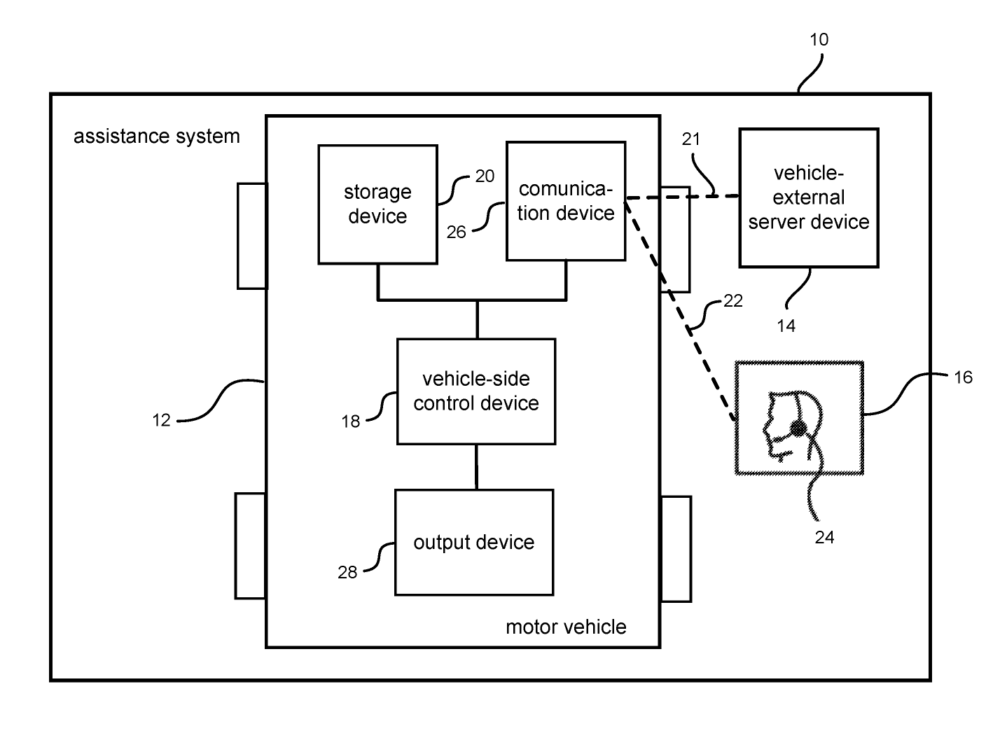

### CROSS REFERENCE TO RELATED APPLICATIONS

This application is the U.S. national stage of International Application No. PCT/EP2016/066747, filed Jul. 14, 2016 and claims the benefit thereof. The International Application claims the benefits of German Application No. 10 2015 213 678.5 filed on Jul. 21, 2015, both applications are incorporated by reference herein in their entirety.

### BACKGROUND

Described below are a method for operating an assistance system and an assistance system.

When a new vehicle is collected, a customer is usually given an extensive introduction into the operator control and display system of the respective motor vehicle. After this, the customer usually has to rely on the information made available in a manual. Even as the customer drives the new vehicle home for the first time, the customer usually receives no further comprehensive support or assistance in terms of the motor vehicle. This can overtax the vehicle driver and, under certain circumstances, also entails risks as a result of unnecessary instructions and can also give rise to irritation on the part of the vehicle driver who is not yet familiar with the operator control and display system of the respective motor vehicle.

US 2013/010710 A1 presents a method for assisting a vehicle occupant during the driving of a motor vehicle. Part of the passenger compartment of the motor vehicle can be detected by a mobile terminal, for example by a smartphone. On the basis of a feature detection system it is detected which displays or operator control elements are currently being sensed by the mobile terminal. Subsequently, an operating instruction relating to the sensed elements of the motor vehicle is output by the mobile terminal. It is disadvantageous here that a vehicle occupant, in particular a vehicle driver, must, under certain circumstances, fiddle around with the mobile terminal while driving, in order to be able to have different vehicle functions explained to him.

DE 10 2007 007 982 A1 and US 2008/0278298 A1 present a method for making available information in a motor vehicle. Information about vehicle systems, vehicle functions and/or vehicle services is stored in a vehicle-side storage device, for example a DVD. As soon as a selection of one of the vehicle systems, of the vehicle functions or of the vehicle services is sensed, in reaction at least some of the information about the selected vehicle system, the selected vehicle function or the selected vehicle service is output by a vehicle-side output device. In this context, components and operator control elements of the motor vehicle which are provided for operator control, use, execution and/or making available of one of the vehicle systems, one of the vehicle functions and/or one of the vehicle services are displayed graphically.

### SUMMARY

The method described below is able to provide improved assistance of a vehicle occupant while operating a motor vehicle.

This is achieved by a method for operating an assistance system and by an assistance system as described below. Advantageous refinements with expedient and non-trivial developments are also described.

In the method for operating an assistance system the following assistance functions are made available:
a) an operating instruction for the motor vehicle, stored on a memory device of at least one motor vehicle;
b) an operating instruction for the motor vehicle stored on a vehicle-external server device;
c) a telephone connection to a customer advisor.

It is determined for which vehicle function of the motor vehicle the provision of assistance for a vehicle occupant is required. At least one of the assistance functions which have been made available is output by at least one output device of the motor vehicle in accordance with the determined vehicle function and/or a sensed user input of the vehicle occupant.

The method provides for different assistance functions or selection functions in the form of onboard assistance, online assistance or in the form of a personal contact to a customer advisor being made available to a vehicle occupant. Depending on which of the different vehicle functions of the motor vehicle the provision of assistance to a vehicle occupant is required for, one or more of the assistance functions can be output by an output device of the motor vehicle. Furthermore, it is also possible to take into account whether the vehicle occupant has just made a certain user input on the basis of which it is possible to detect the vehicle functions for which the occupant requires the provision of assistance. A vehicle occupant can therefore access a variety of functions, both onboard and at the vehicle, as well as online and can also access a personal contact with a customer advisor in order to obtain assistance with operating the motor vehicle.

It is possible to include a plurality of motor vehicles during operation of the assistance system so that a circle variety of vehicle occupants can access the abovementioned assistance functions in various motor vehicles. The vehicle-external server device can be made available, for example, by a vehicle manufacturer and always updated in relation to a wide variety of operating instructions for a wide variety of motor vehicle models. In this context it is also conceivable that synchronization is performed between the vehicle-external service device and the respective storage device the of at least one motor vehicle at regular intervals. In addition, it is also possible that particularly rarely used vehicle functions, such as for example changeover of a windshield wiper or the like, are made available exclusively on the vehicle-external server device, since such vehicle functions are employed very rarely or even not at all by vehicle occupants.

The operating instructions which are made available on the vehicle-side or the vehicle-external server device can be reproduced here, for example, by a display and/or by a corresponding loudspeaker of the motor vehicle. In conjunction with a telephone connection to the customer advisor it is also possible to provide that the customer advisor can access a circle variety of vehicle functions of the motor vehicle, for example via a wireless connection, for example via what is referred to as a remote control function, in order to be able to assist the respective vehicle occupant directly during the execution of different functions. The customer advisor can therefore perform remote control of various functions of the motor vehicle, for example via a wireless connection, in order to explain the method of functioning of one or more vehicle functions to a vehicle occupant.

The functionalities of the assistance system can be made available, for example, in the form of a so-called App, that is to say a program that is installed on the vehicle side. There can be provision that, for example, new vehicles are always equipped with the full functional scope of the assistance system so that customers which have just acquired a new vehicle can access the abovementioned different resources, in order to have, for example, the operator control and display system of the respective motor vehicle explained to them. Therefore, particularly detailed provision of assistance to vehicle occupants is made available by the method, by which assistance they can have a wide variety of functionalities of their motor vehicle explained to them and can be assisted in operating the motor vehicle.

One advantageous embodiment provides that at least part of the functional scope of the assistance functions is limited after a predefined time period. For example, chronological limitation of 3 months after the purchase of a new car can be provided. In order to sense the expiry of the predefined time period, for example a vehicle-side timer or a server-device-side timer can be checked. In particular, it is possible to provide that a warning message relating to the imminent limitation of the functional scope of the assistance function is output on the vehicle side a predefined period of time before expiry of the predefined time period. Therefore, vehicle occupants can be informed in good time that the previously present complete functional scope of the assistance functions will soon be limited. In addition, it is possible to provide that a reduced functional scope of the assistance functions is always made available independently of time, for example a digital user manual or the like. The online assistance or the telephone connection to a customer advisor can, on the other hand, be offered, for example, in a chronologically limited fashion.

A further advantageous embodiment provides that the limitation of the functional scope is canceled again as soon as a predefined enable signal has been received by the vehicle-external server device. For example, the possibility can be made available that a vehicle occupant can buy a type of subscription by which the entirety of, or part of, the functional scope of the assistance system can be booked for a specific period of time. This can be done, for example, directly via a vehicle-side interface, via a smartphone, a computer or the like. As soon as it has been sensed that the subscription has been purchased, the full functional scope of the assistance functions is enabled again, for example, via a corresponding communication between the vehicle-external server device and the respective motor vehicle.

According to a further advantageous embodiment there is provision that the making available and outputting of the assistance functions to the motor vehicle is limited. In other words, there can be provision that the functional scope of the assistance functions is restricted to a single motor vehicle. Irrespective of who drives the motor vehicle or who is in the motor vehicle, any person can access the assistance functions which are made available.

In further advantageous embodiment there is provision that the making available and outputting of the assistance functions is made possible on at least one further motor vehicle if a predefined user authentication has been sensed in the further motor vehicle. In other words, the making available and use of the assistance functions can be made possible, for example, also in a person-bound fashion and over more than one vehicle. If a customer has, for example, a plurality of vehicles and they are from the same vehicle manufacturer, he can therefore use the assistance functions for all of his vehicles. In order to check whether the person who has to access the variety of assistance functions is actually authorized, there can be provision, for example, that on a vehicle side a user authentication is interrogated or has to be input independently by the respective vehicle occupant. In this context, there can be provision, for example, that the user authentication is carried out by a camera system of the further motor vehicle, a mobile terminal which is carried along by a vehicle occupant and/or a user identifier which is input are/is sensed. For example, it is possible to compare, for example by a facial recognition system, whether the respective person is authorized to use the assistance functions. Alternatively, or additionally, there can also be provision, for example, that a mobile radio identifier of the smartphone is interrogated and compared with a stored identifier in order to determine whether the person is authorized. Furthermore, there can for example also be provision that the vehicle occupant simply has to enter a login and a corresponding password in order to authenticate himself. A person can in this context access not only the assistance functions in his own vehicles, but, furthermore, there may, for example, also be provision that he can also access the assistance functions in a hire car, by corresponding authentication, in order to be able to obtain assistance with respect to the various functions of the hire care.

A further advantageous embodiment provides that the assistance functions are displayed and made available as soon as a predefined user action of the vehicle occupant has been sensed. For example, an assistance pushbutton key can be made available in the motor vehicle, wherein the assistance functions are made available and displayed as soon as it has been sensed that the vehicle occupant has activated this assistance pushbutton key. Alternatively, or additionally, there can also be provision that the vehicle occupant has to execute a predefined gesture, for example an upwardly directed thumb or the like, as a consequence of which the assistance functions are then made available and displayed. In addition, it is also possible that the vehicle occupant has to utter, for example, a predefined voice command, as a consequence of which the assistance functions are then made available and displayed. For example, the vehicle occupant can say the following: “please drive me using the radio transmitter programming”. As soon as this voice command has been sensed, component(s) capable of providing suitable assistances are selected to produce output. In addition there can also be provision that only those assistance functions which can actually make available appropriate assistance for the respective vehicle function are displayed, for example by a display of the motor vehicle. In this way, on the one hand, a variety of possibilities are available for the actuation of the assistance functions and, on the other hand, the respective vehicle occupant is prevented from being swamped with information, since only those assistance functions which can assist the vehicle occupant to solve an existing problem are also displayed.

According to a further advantageous embodiment there is provision that the assistance functions are made available and displayed as soon as it has been sensed on the basis of at least one predefined criterion that the vehicle occupant has problems while operating at least one of the vehicle functions. For example, it could be the case that the vehicle occupant has problems while operating the navigation system of the motor vehicle because he is simply not able to enter a further intermediate destination. If it is sensed on the vehicle side that in this context, for example, a plurality of incorrect operating actions take place and simply no intermediate destination has been correctly added, it can be interrogated on the vehicle side whether the vehicle occupant requires assistance while operating the navigation system. Furthermore, it is, for example, also possible that while operating a wide variety of vehicle functions it is checked how long the vehicle occupant requires when operating the respective vehicle function. If the operator control time exceeds a predefined operator control time, it is probable that the vehicle occupant is currently having problems with the operator control of the respective vehicle function, as a consequence of which there can also be a vehicle-side interrogation as to whether the vehicle occupant requires assistance. The assistance system can therefore also detect independently whether the assistance functions are to be offered to the respective vehicle occupant. This can contribute to allowing the respective vehicle occupant to operate a circle variety of functionalities of the motor vehicle even more easily.

In a further advantageous refinement there is provision that for the determined vehicle function of the motor vehicle for which the provision of assistance is required for the vehicle occupant, at least one operator control element of the motor vehicle, which is necessary to operate the respective vehicle function, is determined as a further assistance function, and a lighting intensity of the operator control element is increased and a lighting intensity of the other operator control elements of the motor vehicle is reduced. Usually, vehicle-side operator control elements, such as for example pushbutton keys, switches and the like, have rear-sided illumination. As soon as it is then determined that the vehicle occupant is currently having problems with operating a specific vehicle function, at least one operator control element in the passenger compartment of the vehicle which has to be activated in order to operate the vehicle function is determined. The illumination intensity of backlighting or illumination of this operator control element is increased, causing the element to be visually highlighted, with the result that the vehicle occupant's attention is drawn to this operator control element. In order to draw the vehicle occupant's attention only to this operator control element there is provision that at the same time the illumination intensity of the backlighting or illumination of the other operator control elements which do not have to be activated in order to operate the respective vehicle function is reduced. In other words the illumination intensity of the respective operator control element is thus increased relative to the illumination intensity of the other operator control elements. This described provision of assistance can also be combined, for example, with the provision of assistance by a customer advisor by telephone in that the customer advisor regulates the illumination intensity of the operator control elements via a wireless connection to the motor vehicle.

A further advantageous embodiment provides that an operator control sequence of a plurality of operator control elements of the motor vehicle for operating the respective vehicle function is determined as a further assistance function for the determined vehicle function of the motor vehicle for which the provision of assistance for the vehicle occupant is required, and the operator control sequence of these operator control elements is displayed by a display device of the motor vehicle, in particular in the form of an animation. For example, the operator control elements which are necessary to operate the vehicle function and are displayed in a graphic menu, and the remaining operator control elements which are not necessary to operate the respective vehicle function are displayed grayed out. The necessary operator control elements may be displayed successively in the form of an animation in a way which corresponds to the operator control sequence. For example, a type of virtual finger trace can be displayed which wanders from one operator control element to the next in accordance with the operator control sequence.

The assistance system described herein includes at least one motor vehicle and one vehicle-external server device. Furthermore, the assistance system has a vehicle-side control device which is designed to determine for which vehicle functions of the motor vehicle the provision of assistance for the vehicle occupant is required. Furthermore, the vehicle-side control device is designed to make available the following assistance functions:

a) an operating instruction for the motor vehicle, stored on a memory device of the motor vehicle;

b) an operating instruction for the motor vehicle; stored on the vehicle-external server device; and

c) a telephone connection to a customer advisor.

The control device is also designed to actuate an output device of the motor vehicle in accordance with the determined vehicle function and/or a sensed user input of the vehicle occupant in order to output at least one of the assistance functions which are made available. Advantageous refinements of the method are to be considered advantageous refinements of the assistance system, wherein the assistance system has, in particular, component(s) for carrying out the method.

Further advantages, features and details can be found in the following description of exemplary embodiments and with reference to the drawing. The features and combinations of features specified above in the description and those features and combinations of features which are specified below in the description of the figures and/or merely shown in the figures can be used not only in the respectively indicated combination but also in other combinations or alone without departing from the scope of the invention.

### BRIEF DESCRIPTION OF THE DRAWINGS

These and other aspects and advantages will become more apparent and more readily appreciated from the following description of the exemplary embodiments, taken in conjunction with the accompanying drawings of which

The single FIGURE is a schematic block diagram of an assistance system which has a motor vehicle, a vehicle-external server device and a service center.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

An assistance system 10 having a motor vehicle 12, a vehicle-external server device 14 and having a service center 16 is shown in a schematic illustration in the single FIGURE. The assistance system 10 can, furthermore, also have a multiplicity of further motor vehicles which are not illustrated here. The assistance system 10 serves to make available a circle variety of provisions of assistance relating to a wide variety of vehicle functions of the motor vehicle 12 to a vehicle occupant, wherein the same applies to further motor vehicles (not illustrated here) and corresponding vehicle occupants.

The motor vehicle 12 includes a vehicle-side control device 18 which is designed to determine for which vehicle functions of the motor vehicle 12 the provision of assistance to a vehicle occupant is required. The vehicle function may be essentially any vehicle function such as an air-conditioning system, an on-board computer, a navigation system and the like. The control device 18 is also designed to make available the following assistance functions: an operator instruction for the motor vehicle 12, stored on a storage device 20 of the motor vehicle 12; an operating instruction for the motor vehicle 12, stored on the vehicle-external server device 14; and a telephone connection 22 to a customer advisor 24 of the service center 16. The telephone connection 22 can be made here, for example, via a mobile radio link or by another form of wireless connection. In order to produce the telephone connection 22 and to communicate with the vehicle-external server device 14, the motor vehicle 12 has a communication device 26 which is correspondingly configured for this.

The control device 18 is also designed to actuate an output device 28 of the motor vehicle 12 in accordance with the determined vehicle function and/or a sensed user input of the vehicle occupant in order to output at least one of the assistance functions which are made available. The output device 18 can have in this context one or more displays and also one or more loudspeakers, so that the operating instructions can be reproduced both graphically and acoustically, wherein, furthermore, it is also made possible for a telephone call to be made with the customer advisor 24.

A method for operating the assistance system 10 will be explained in more detail below. The assistance functions are made available and displayed, for example, by a display of the motor vehicle as soon as a predefined user action of the vehicle occupant of the motor vehicle 12 has been sensed. For example, it may be the case that the vehicle occupant has difficulty while operating a navigation system of the motor vehicle and activates a correspondingly provided assistance pushbutton key in the motor vehicle, for example on a touchscreen or the like. Furthermore, there can also be provision that the vehicle occupant carries out a predefined assistance gesture or utters a correspondingly predefined voice command, as a consequence of which the assistance functions are made available and displayed.

Alternatively, or additionally there can also be provision that the assistance functions are made available and displayed as soon as it has been sensed on the basis of at least one predefined criterion that the vehicle occupant is having problems while operating at least one of the vehicle functions. If the vehicle occupant has difficulties, for example, while operating the navigation system of the motor vehicle 12, this can be sensed, for example, by virtue of the fact that it takes much too long to enter an intermediate destination or always carries out incorrect control operations on the navigation system. As a consequence of this there can be provision that the assistance functions are made available automatically and displayed by a display of the motor vehicle 12.

In this context there can be provision that depending on which of the vehicle functions the vehicle occupant requires the provision of assistance for, a selection menu is displayed, wherein only those assistance functions by which the vehicle occupant can be assisted in respect of the currently present problematic situation are also displayed.

The full functional scope of the assistance system 10 in relation to the assistance functions which can be made available and can be called can be limited, for example, to a predefined time period. For example, the motor vehicle 12 could be a new vehicle which has just been picked up by a customer. On a standard basis, for example the entire functional scope of the assistance system 10 in respect of the assistance functions can be made available at the factory, wherein for example 3 months after the delivery of the motor vehicle 12 the functional scope in relation to the assistance functions is considerably reduced. In this context a certain period of time, for example a week, before the expiry of the limitation of the functional scope of the assistance functions a corresponding warning message may be output on the vehicle side so that the respective vehicle occupant is informed that soon all the assistance functions will no longer be made available to him free of charge.

As a consequence of this, the vehicle occupant can, insofar as he does not wish any limitation of the functional scope in relation to the assistance functions, purchase a type of subscription so that by making a payment he can continue to enjoy the full functional scope of the assistance functions for a specific operating duration. The purchasing of the subscription can be carried out, for example, directly via a vehicle-side interface, via a smartphone, via a computer or the like. As soon as the subscription has been purchased, corresponding information is stored, for example, on the vehicle side and in the vehicle-external server device 14. Subsequently, the vehicle occupant can continue to access a full functional scope of the assistance functions.

In this context there can be provision that the making available and output of the assistance functions is limited precisely to this motor vehicle 12. If, for example, a plurality of persons wish to use the motor vehicle 12, there can be provision that the respective assistance functions can be made available and output independently of the person as long as these assistance functions relate to the motor vehicle 12. Alternatively, there can also be provision that the making available and outputting of the assistance functions is made possible at a plurality of motor vehicles, that is to say to more than one motor vehicle. For example, there can be provision that a vehicle owner is assigned a specific use identifier which authorizes him to call and to use all the assistance functions which are booked by him.

In order to be able to access the assistance functions which are bought by him, there can be provision, for example, that the respective vehicle occupant, or also other persons if they have the corresponding access data, firstly have to carry out corresponding user authentication in the motor vehicle 12 or also in any other motor vehicles. The user authentication can be carried out, for example, by a camera system of the respective motor vehicle, by sensing a mobile terminal carried along by a vehicle occupant such as, for example, a smartphone or the like, and/or by sensing a user identifier which is input into the respective motor vehicle.

As soon as the respective vehicle occupant authenticates himself successfully, he can access the assistance functions bought by him, irrespective of the vehicle in which he is currently sitting. His user identifier can be stored, for example, in the vehicle-external server device 14 so that a corresponding comparison between the respective motor vehicle and the vehicle-external server device 14 can be used to carry out the authentication. In particular, if a person uses a multiplicity of vehicles, whether because he has a particularly large number of vehicles or frequently travels with hire cars, the person can access a multiplicity of useful assistance functions, in particular by purchasing the subscription, so that in a wide variety of motor vehicles he can familiarize himself with the operator control and display system of the vehicles particularly quickly.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for operating an assistance system of at least one motor vehicle, comprising:
making available assistance functions, including:
a first operating instruction for the at least one motor vehicle, stored on a memory device of the at least one motor vehicle,
a second operating instruction for the at least one motor vehicle stored on a vehicle-external server device, and
a telephone connection to a customer advisor;
determining that a vehicle occupant of a specific motor vehicle, included among the at least one motor vehicle, requires assistance to control a vehicle function of the specific motor vehicle;
producing output of at least one of the assistance functions, by at least one output device of the specific motor vehicle, in accordance with at least one of the vehicle function determined by said determining and a sensed user input of the vehicle occupant.

13. The method according to claim 12, further comprising limiting at least part of a functional scope of the assistance functions a predefined time period after a change in possession of the specific motor vehicle.

14. The method according to claim 13, further comprising canceling the limiting of the functional scope upon receipt of a predefined enable signal by the vehicle-external server device.

15. The method according to claim 12, further comprising limiting said making available of the assistance functions and said producing output of the at least one of the assistance functions.

16. The method according to claim 12,
wherein the at least one motor vehicle, having the assistance functions made available, includes at least one further motor vehicle, and
further comprising producing output of the at least one of the assistance functions in one of the at least one further motor vehicle when a predefined user authentication has been sensed in the one of the at least one further motor vehicle.

17. The method according to claim 16, further comprising performing the predefined user authentication by at least one of
a camera system of the one of the at least one further motor vehicle,
a device sensing a mobile terminal carried by the vehicle occupant when in the one of the at least one further motor vehicle, and
an input device sensing a user identifier input at the one of the at least one further motor vehicle.

18. The method according to claim 12, wherein said making available of the assistance functions includes generating a display of the assistance functions available, upon sensing a predefined user action of the vehicle occupant.

19. The method according to claim 12, wherein said making available of the assistance functions includes generating a display of the assistance functions available upon detecting, based on at least one predefined criterion, that the vehicle occupant has difficulty operating at least the vehicle function determined to have assistance required.

20. The method according to claim 12, further comprising:
determining a further assistance function of the specific motor vehicle, necessary for provision of the assistance to the vehicle occupant, associated with at least one operator control element of the specific motor vehicle;
increasing, to a first lighting intensity, lighting of the at least one operator control element; and
decreasing, to a second lighting intensity, lighting of other operator control elements of the specific motor vehicle not included in the at least one operator control element.

21. The method according to claim 12, further comprising:
determining, as a further assistance function of the specific motor vehicle, an operator control sequence manipulating operator control elements of the specific motor vehicle required by the vehicle function of the motor vehicle for provision of assistance to the vehicle occupant, and
displaying the operator control sequence of the operator control elements by a display device of the specific motor vehicle.

22. The method according to claim 12, wherein the displaying produces an animation.

23. An assistance system, comprising
a vehicle-external server device; and
at least one motor vehicle, each including
a memory device;
a vehicle-side control device configured to
determine that a vehicle occupant of the motor vehicle, where the vehicle-side control device is located, requires assistance to control a vehicle function; and
make available assistance functions, including:
a first operating instruction for the motor vehicle, stored on the memory device of the at least one motor vehicle,
a second operating instruction for the motor vehicle; stored on the vehicle-external server device, and
a telephone connection to a customer advisor; and
at least one output device configured to output, in accordance with at least one of the vehicle function determined to have assistance required and a detected user input of the vehicle occupant, at least one of the assistance functions that are available.

24. The assistance system according to claim 23, wherein the output device in each of the at least one motor vehicle is further configured to output the at least one of the assistance functions when a predefined user authentication has been sensed.

25. The assistance system according to claim 23, wherein each of the at least one motor vehicle further includes, to perform the predefined user authentication, at least one of
a camera system;
a sensor sensing a mobile terminal carried by the vehicle occupant; and
an input device sensing a user identifier input.

26. The assistance system according to claim 23,
wherein each of the at least one motor vehicle further includes a detection device configured to detect a predefined user action of the vehicle occupant, and
wherein the at least one output device in each of the at least one motor vehicle is further configured to display the assistance functions available when the predefined user action of the vehicle occupant is detected.

27. The assistance system according to claim 23,
wherein each of the at least one motor vehicle further includes a detection device configured to detect, based on at least one predefined criterion, that the vehicle occupant has difficulty operating at least the vehicle function determined to have assistance required, and
wherein the at least one output device in each of the at least one motor vehicle is further configured to display the assistance functions available when the detection device detects that the vehicle occupant has difficulty operating at least the vehicle function determined to have assistance required.

28. The assistance system according to claim 23,
wherein each of the at least one motor vehicle further includes operator control elements, and
wherein the vehicle-side control device in each of the at least one motor vehicle is further configured to
determine a further assistance function of the motor vehicle, necessary for provision of the assistance to the vehicle occupant, associated with at least one of the operator control elements;
increase, to a first lighting intensity, lighting of the at least one operator control element; and
decrease, to a second lighting intensity, lighting of other operator control elements of the motor vehicle not included in the at least one operator control element.

29. The assistance system according to claim 23,
wherein each of the at least one motor vehicle further includes operator control elements,
wherein the vehicle-side control device in each of the at least one motor vehicle is further configured to determine, as a further assistance function, an operator control sequence manipulating at least two of the operator control elements required by the vehicle function for provision of assistance to the vehicle occupant, and
wherein each of the at least one motor vehicle further includes a display device configured to display the operator control sequence of the at least two of the operator control elements.

30. A motor vehicle communicating with a vehicle-external server device, comprising:
a memory device;
a vehicle-side control device configured to
determine that a vehicle occupant of the motor vehicle requires assistance to control a vehicle function; and
make available assistance functions, including:
a first operating instruction for the motor vehicle, stored on the memory device,
a second operating instruction for the motor vehicle; stored on the vehicle-external server device, and
a telephone connection to a customer advisor; and
at least one output device configured to output, in accordance with at least one of the vehicle function determined to have assistance required and a detected user input of the vehicle occupant, at least one of the assistance functions that are available.

31. The motor vehicle according to claim 30,
further comprising:
operator control elements, and
a display device,
wherein the vehicle-side control device is further configured to determine, as a further assistance function, an operator control sequence manipulating at least two of the operator control elements required by the vehicle function for provision of assistance to the vehicle occupant, and
wherein the display device is configured to display the operator control sequence of the at least two of the operator control elements.
